(19) United States
(12) Patent Application Publication
(10) Pub. No.: US 2012/0050626 A1
(43) Pub. Date: Mar. 1, 2012

(54) ON-VEHICLE DISPLAY DEVICE

(76) Inventors: Kazuhiro Tsuzuki, Tokyo (JP); Masahiro Kanamaru, Tokyo (JP); Jiro Yoshizawa, Tokyo (JP)

(21) Appl. No.: 13/318,438

(22) PCT Filed: Aug. 7, 2009
(86) PCT No.: PCT/JP2009/003807

§ 371 Date: Nov. 1, 2011

(51) Int. Cl. H04N 5/64

(52) U.S. Cl. 348/837; 348/E05.128

(57) ABSTRACT

A monitor 1 is housed inside a casing 2 attached to a vehicle ceiling 10, and a monitor locking hook 6 locks a locking hole 1c. As a lock release button 7 is pushed to release the lock, a spring 3 located on one end side of a rotation shaft 1a rotates the monitor 1 to open the monitor 1. At that time, a gear 4 located on the other end side of the rotation shaft 1a meshes with a gear dumper 5 of the casing 2 to control the rotational speed of the monitor 1. As the stopper 9 of the monitor 1 abuts against the stopper receiver 8, the rotation thereof is stopped and the posture of the monitor 1 is held by the tension of the spring 3.

### TECHNICAL FIELD

The present invention relates to an in-vehicle display apparatus that is used with a monitor suspended from the inside of an apparatus casing secured to a vehicle ceiling.

### BACKGROUND ART

Conventionally, a display apparatus mounted on a vehicle ceiling is housed inside an apparatus casing secured to the ceiling face with the monitor screen substantially horizontal to the ceiling face. In viewing, the monitor is rotated to be opened to a viewable angle thereof, and be used with the monitor suspended from the apparatus casing. In such an in-vehicle display apparatus, there are conventionally some in which the monitor is manually opened to the viewable angle, while others in which the monitor is automatically opened thereto.

In the case of a manually opened and closed display apparatus, a base plate fixed to an apparatus casing is provided with a rotation shaft hole, a monitor rotation shaft is rotatably passed through the rotation shaft hole, and further a leaf spring is fixed to the monitor rotation shaft with pressed against the base plate. Moreover, a plurality of concavities are formed in the base plate, and a convex is formed in the leaf spring. In the state where the monitor is housed inside the apparatus casing, the convex of the leaf spring is fitted in one of the plurality of concavities on the base plate to horizontally hold the monitor. In using the monitor, a viewer manually rotates the monitor to release the fit between the concavity and the convex, and further continues to rotate the monitor to open the monitor until the convex is fitted in another concavity. By the fit between the concavity and the convex, the monitor is held at the viewable angle. Thus, in housing and viewing the monitor, the convex is fitted in the concavity to hold the angle of the monitor, and also the tension of the leaf spring counteracts the chatter vibration of the monitor.

In the case of an automatically opened and closed display apparatus, there is provided with a motor serving as a driving source for rotating a monitor, and a gear mechanism between the motor and a monitor rotation shaft thereof. In using the monitor, when a viewer rotates the motor in a forward direction by a remote control operation or the like, the gear mechanism reduces the driving force of the motor to transmit the driving force to a monitor rotation shaft, and the monitor is rotated and opened to the viewable angle (for example, see Patent Document 1).

### PRIOR ART DOCUMENTS

### Patent Documents

Patent Document 1: JP-A-2007-125961

### SUMMARY OF THE INVENTION

Since the conventional in-vehicle display apparatus is arranged as discussed above, for a manually opened and closed display apparatus, a viewer has to open a monitor to the angle at which the monitor can be viewed, thus deteriorating ease of operation. On the other hand, the automatically opened and closed display apparatus can improve operability thereof; however, there are problems such that the display apparatus requires complicated arrangements in a motor, a gearing mechanism and so on, and further that the in-vehicle display apparatus has to be increased in size because of an internal disposal of the arrangements.

The present invention has been made to solve the above-discussed problems, and an object of the invention is to automatically smoothly open a monitor with a small number of constituent components and a relatively simple constitution and also reduce an in-vehicle display apparatus in size.

The in-vehicle display apparatus according to the present invention is arranged to include a spring that is attached to a rotation shaft of a monitor, and urges the monitor in the opening direction of the monitor; a gear that is fixed to the rotation shaft, and rotates integrally with the rotation shaft; a gear dumper that is fixed to a casing, and meshes with the gear to produce resisting force against the urging force of the spring; a stopper projecting from the tip of the monitor on the side in which the rotation shaft is provided; and a stopper receiver provided in the position of the casing in which the casing abuts against the stopper when the monitor is rotated to a predetermined angle.

According to the present invention, when the spring and the gear are provided around the rotation shaft, and the gear dumper meshed with the gear is disposed in the casing, the monitor can be automatically smoothly opened with a small number of constituent components and with a relatively simple mechanism, and also the in-vehicle display apparatus can be downsized.

### BRIEF DESCRIPTION OF THE DRAWINGS

FIG. 1 is an external perspective view showing an arrangement of an in-vehicle display apparatus according to a first embodiment of the present invention, and shows a housed state of a monitor.

FIG. 2 is a perspective view showing an arrangement of the in-vehicle display apparatus shown in FIG. 1 around a monitor rotation shaft thereof.

FIG. 3 is a perspective view showing gear rotation positions of the in-vehicle display apparatus shown in FIG. 1; FIG. 3(a) shows a housed state of the monitor, and FIG. 3(b) shows a viewing state thereof.

FIG. 4 is a perspective side view showing an arrangement of the in-vehicle display apparatus shown in FIG. 1 on the side of a spring thereof; FIG. 4(a) shows a housed state of the monitor and FIG. 4(b) shows a viewing state thereof.

FIG. 5 is a perspective side view showing an arrangement of the in-vehicle display apparatus shown in FIG. 1 on the side of the gear; FIG. 5(a) shows a housed state of the monitor, and FIG. 5(b) shows a viewing state thereof.

### BEST MODE FOR CARRYING OUT THE INVENTION

In the following, embodiments of the present invention will be described with reference to the accompanying drawings in order to explain the present invention in more detail.

### First Embodiment

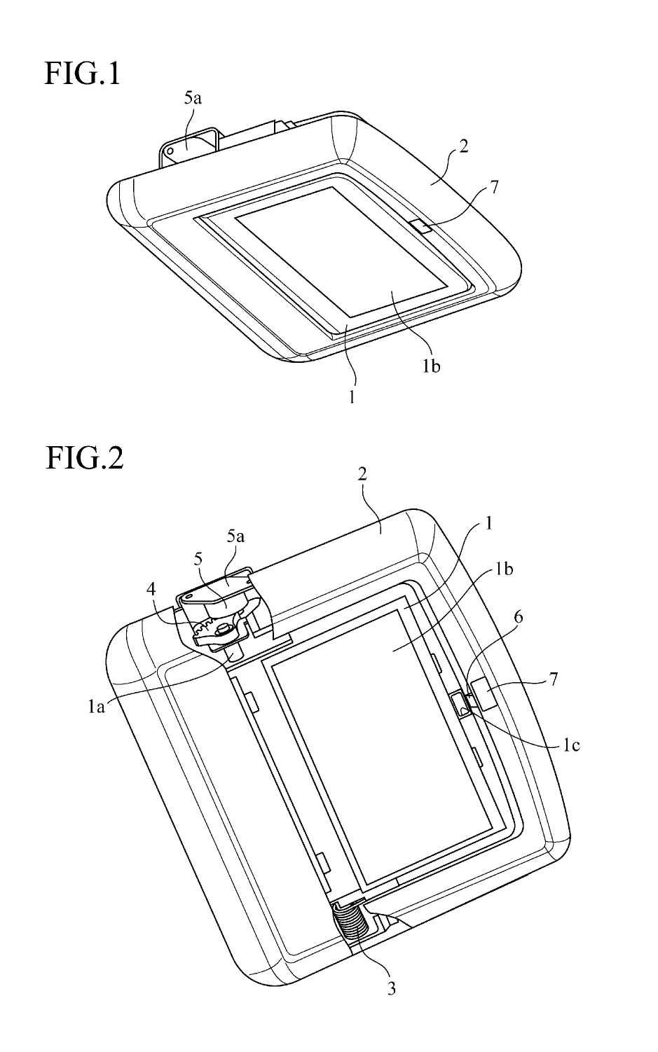

FIG. 1 is an external perspective view showing an arrangement of an in-vehicle display apparatus according to a first embodiment of the present invention, and shows a housed state of a monitor 1. FIG. 2 is a perspective view showing an arrangement of the in-vehicle display apparatus around a rotation shaft 1a of the monitor 1, with the exterior thereof partially omitted.

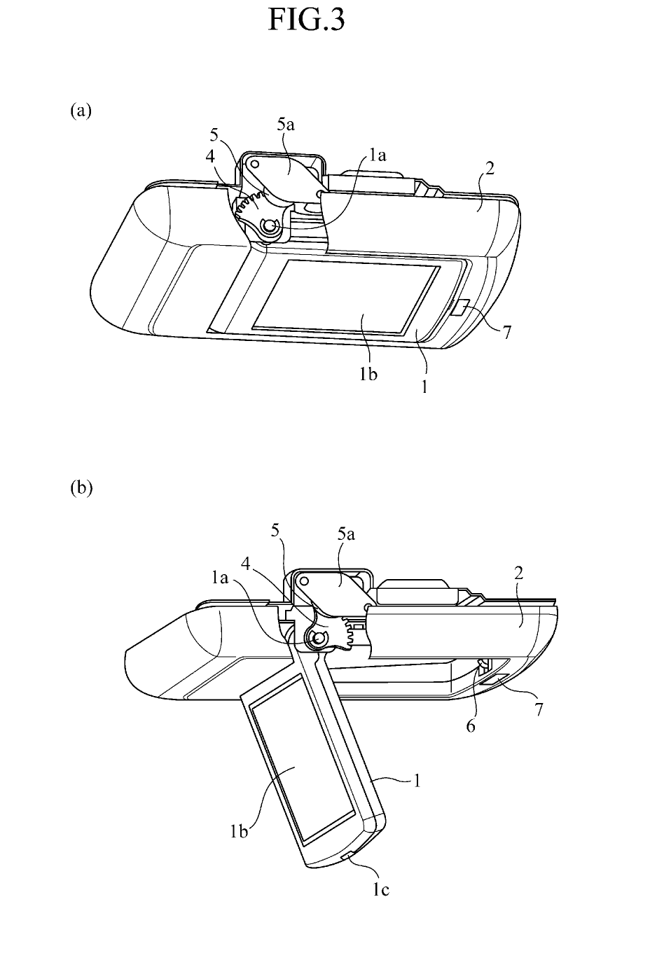

The in-vehicle display apparatus is attached to a vehicle ceiling on the side of a casing 2 thereof, and the monitor 1 is housed inside the casing 2 to be substantially horizontal to the ceiling face. A rotation shaft 1a is connected to the monitor 1, and the monitor 1 is rotated (opened and closed) about the rotation shaft 1a relative to the casing 2. FIG. 3 is a perspective view showing rotation positions of a gear 4 of the in-vehicle display apparatus; FIG. 3(a) shows a housed state of the monitor 1, and FIG. 3(b) shows a viewing state of the monitor 1. Note that in the first embodiment, the state where the monitor 1 is opened 70 degrees from the casing 2 is referred to as the viewing state.

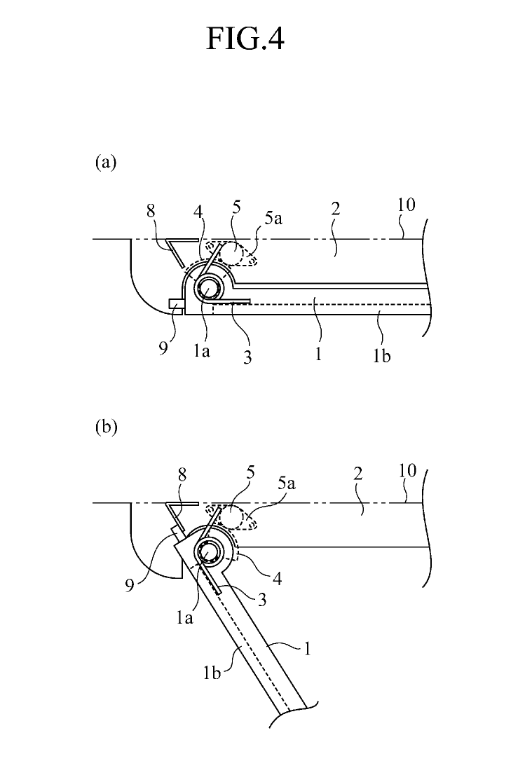

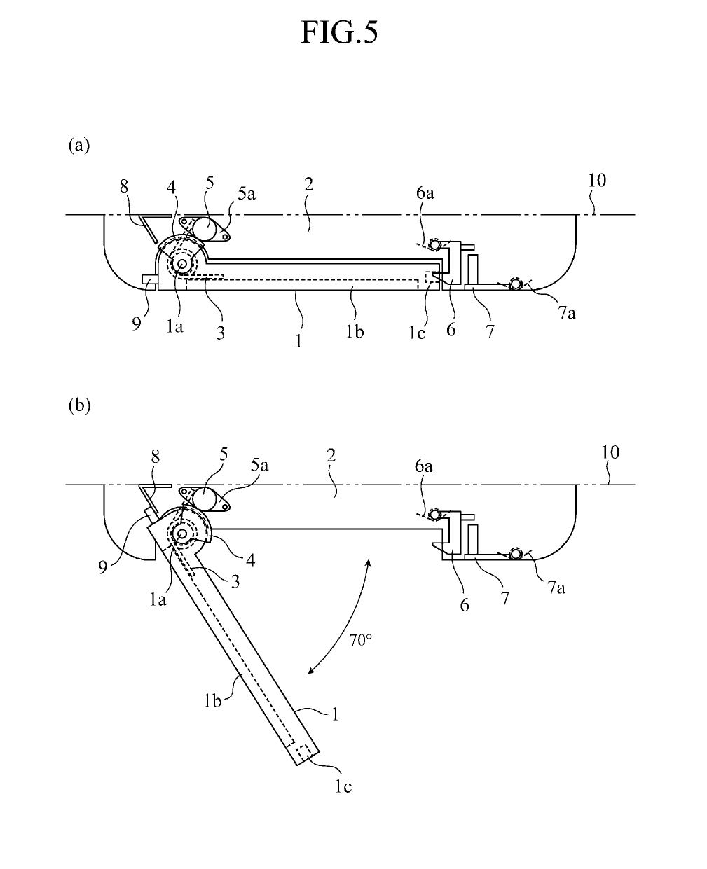

FIG. 4 is a perspective side view showing an arrangement of the in-vehicle display apparatus on the side of a spring 3 thereof; FIG. 4(a) shows a housed state thereof, and FIG. 4(b) shows a viewing state thereof. As shown in FIG. 4, the spring 3 is wound around one end of the rotation shaft 1a; one arm of the spring 3 is fixed to the monitor 1, and the other arm thereof is fixed to the casing 2. The spring 3 normally imparts tension in the opening direction of the monitor 1 to the rotation shaft 1a.

FIG. 5 is a perspective side view showing an arrangement of the in-vehicle display apparatus on the side of a gear 4 thereof; FIG. 5(a) shows a housed state thereof, and FIG. 5(b) shows a viewing state thereof. As shown in FIG. 5, the gear 4 is secured to the other end of the rotation shaft 1a, and the rotation shaft 1a and the gear 4 is rotated integrally with each other. The gear 4 is a sector in shape having a central angle (70 degrees or more, in the example) which is slightly larger than an angle which is rotated from the housed position to the viewing position, and has teeth formed around the circular arc portion thereof. Further, a gear dumper 5 having a base plate 5a is attached to the casing 2 on the other-end side of the rotation shaft 1a. When the monitor 1 is rotated, the gear dumper 5 is rotated in engagement with the gear 4, and produces resistance against the tension of the spring 3.

Moreover, as shown in FIG. 5, a locking hole 1c is provided on the side of the distal end of rotation that is opposite to the side where the rotation shaft 1a of the monitor 1 is provided. In the other housing 2, a monitor locking hook 6 and a lock release button 7 is provided in the position facing the locking hole 1c of the monitor 1 placed in the housed position. The monitor locking hook 6 hooks the locking hole 1c of the monitor 1 with a claw thereof by the tension of a monitor locking hooking spring 6a to lock the monitor 1 inside the casing 2. The lock release button 7, when a portion thereof exposed to the outside is pushed up by a viewer, is upwardly moved against the tension of a lock release button spring 7a, to release the lock between the monitor locking hook 6 and the locking hole 1c.

Further, a stopper 9 is protrusively provided at the tip of the monitor 1 on the side where the rotation shaft 1a is provided. In the other casing 2, a stopper receiver 8 is raisedly provided at an angle (70 degrees, in the example) corresponding to the viewing position of the monitor 1.

Next, the operation of the in-vehicle display apparatus will be described.

In the housed state as shown in FIG. 5(a), the monitor locking hook 6 of the casing 2 hooks the locking hole 1c of the monitor 1 to hold the monitor 1 such that the posture thereof is held substantially horizontal to the vehicle ceiling 10. Further, the monitor 1 is pushed in the opening direction by the tension of the spring 3, and thus even when receiving vehicle vibration, chatter vibration is counteracted.

When the lock between the monitor locking hook 6 and the locking hole 1c is released, the monitor 1 can burst open by the tension of the spring 3 and the self-weight fall of the monitor 1, and thus, there is a possibility to reduce salability thereof. However, the gear 4 for rotating integrally with the rotation shaft 1a meshes with the gear dumper 5 to continue producing resistance in a direction opposite to the tension of the spring 3, and thus the monitor 1 is smoothly rotated. Further, in the housed state thereof, by simply pushing the lock release button 7, a viewer can automatically smoothly rotate the monitor 1 to a viewable position.

Incidentally, the rotational speed of the monitor 1 can be controlled by either adjusting the gear ratio between the gear 4 and the gear dumper 5 or adjusting the resistance of the gear dumper 5. In the first embodiment, the gear dumper 5 is employed, having the characteristic of increasing the resistance as the speed of rotation is increased, and further the gear ratio between the gear dumper 5 and the gear 4 is set to 1:2, the gear dumper 5 is rotated twice as fast as the gear 4 to obtain high resistance.

As shown in FIG. 5(b), the rotation of the monitor 1 is stopped when the stopper 9 abuts against the stopper receiver 8. A viewer views a monitor screen 1b of the monitor 1 placed in the state of the angular position shown in FIG. 5(b). Since the monitor 1 in the viewing state is normally pushed in the opening direction by the tension of the spring 3 to be thereby held in the same state, and is not rotated in the reverse direction by self-weight; also, even when receiving vehicle vibration, chatter vibration thereof is suppressed.

Hereupon, it is required that the in-vehicle display apparatus mounted on the vehicle ceiling 10 be downsized to deal with the case of the narrowed mounting area on the ceiling because of a sunroof or the like. Therefore, in the first embodiment, the monitor 1 is automatically rotated with a small number of constituent components consisting of the spring 3, the gear 4, and the gear dumper 5, and also with a relatively simple mechanism, thus eliminating the necessity of a complicated mechanism such as a motor and a gear mechanism to be thus downsized. Further, when the spring 3 is arranged on the one-end side of the rotation shaft 1a of the monitor 1, and the gear 4 and the gear dumper 5 are arranged on the other-end side, the display apparatus can be downsized as compared with the case of arranging the spring 3, the gear 4, and the gear dumper 5 at each end of the rotation shaft 1a, and also the apparatus can keep a proper balance between the right and left to thus enhance flexibility in design thereof. In particular, when a large spring 3 is employed to enable the monitor 1 to be held in the viewing state by an urging force larger than the self-weight of the monitor 1, there is a large advantage in separately arranging the spring 3, and the gear 4 and the gear dumper 5.

Moreover, the in-vehicle display apparatus mounted on the vehicle ceiling 10 is generally attached to the ceiling between a driver's seat and a rear seat. Therefore, slimness of the in-vehicle display apparatus in the housed state of the monitor 1 is required to ensure the vision of a driver toward the rear. For this reason, in the first embodiment, when the gear 4 is formed in the shape of a sector, a gear diameter necessary for adjusting the rotational speed of the monitor 1 is secured, and also the slimness of the in-vehicle display apparatus in thickness is achieved. Furthermore, the gear dumper 5 is not arranged right above the rotation shaft 1a, but arranged obliquely thereabove, which enables further slimness of the in-vehicle display apparatus. Moreover, when the gear 4 is formed in the shape of a sector, the gear 4 is not exposed externally of the casing 2 when the monitor 1 is opened, and thus it is possible to improve the appearance of the product.

As discussed above, according to the first embodiment, in the in-vehicle display apparatus that rotates the monitor 1, which is housed inside the casing 2 secured to the ceiling 10 of a vehicle, in a gravitational direction to a viewing position, the in-vehicle display apparatus is arranged to includes the spring 3 that is attached to the rotation shaft 1a of the monitor 1, and urges the monitor 1 in the opening direction thereof; the gear 4 that is fixed to the rotation shaft 1a, and rotates integrally with the rotation shaft 1a; the gear dumper 5 that is fixed to the casing 2, and meshes with the gear 4 to produce resistance in a direction opposite to the urging force of the spring 3; the stopper 9 projecting from the tip of the monitor 1 on the side where the rotation shaft 1a is provided; and the stopper receiver 8 provided in the position of the casing 2 where the casing abuts against the stopper 9 as the monitor 1 is opened to the viewing position. Therefore, the monitor 1 can be automatically smoothly opened with a small number of constituent components and a relatively simple mechanism to enhance operability thereof. Further, the in-vehicle display apparatus can be downsized.

Further, according to the first embodiment, it is arranged that the spring 3 is attached to one end side of the rotation shaft 1a, and that the gear 4 is fixed to the other end side of the rotation shaft 1a. Consequently, the in-vehicle display apparatus can be further downsized. Moreover, the apparatus can keep a proper balance between the two ends of the rotation shaft 1a to enhance flexibility in design thereof.

Moreover, according to the first embodiment, it is arranged that the spring 3 has an urging force for holding the monitor 1 in the viewing position as the stopper 9 abuts against the stopper receiver 8. In such a way, since the urging force of the spring 3 is increased to impart vibration resistance to the monitor 1, the monitor 1 in both of the housed and viewing positions is normally pushed in the opening direction by the tension of the spring 3, and even when receiving vehicle vibration, chatter vibration thereof is restricted.

Further, according to the first embodiment, it is arranged that the gear 4 has the shape of a sector, and the central angle thereof is substantially equal to the viewing angle of the monitor 1. Therefore, the gear 4 can be housed inside the casing 2 even in the state where the monitor 1 is opened. Thus, it is possible to reduce the in-vehicle display apparatus in thickness, and improve the appearance of the product.

It should be noted that in the first embodiment, in FIG. 1 to FIG. 5, the constitutional example where the spring 3 is attached to one end side of the rotation shaft 1a, the gear 4 is attached to the other end side thereof, and also the gear dumper 5 is disposed thereon; however, the present invention is not limited thereto. It may be arranged that the spring 3 and the gear 4 are attached on the one end side of the rotation shaft 1a while the gear dumper 5 is disposed thereon, and that also the spring 3 and the gear 4 are attached on the other end side thereof while the gear dumper 5 is disposed thereon. Even in the case of such an arrangement, the monitor 1 can be automatically smoothly opened with a small number of constituent components and with a relatively simple mechanism to thus enhance operability thereof and also achieve downsizing of the in-vehicle display apparatus.

### INDUSTRIAL APPLICABILITY

As discussed above, since the in-vehicle display apparatus according to the present invention is arranged to automatically rotate the monitor 1 with a simple mechanism using the spring 3, the gear 4, and the gear dumper 5, it is suitable for use in an in-vehicle display apparatus, especially, requiring vibration resistance such as a display apparatus where a monitor is suspended from a ceiling to be viewed.

1. An in-vehicle display apparatus that rotates a monitor housed inside a casing secured to a ceiling of a vehicle in a gravitational direction to a predetermined angle, the apparatus comprising:
a spring that is attached to a rotation shaft of the monitor, and urging the monitor in an opening direction;
a gear that is fixed to the rotation shaft, and rotates integrally with the rotation shaft;
a gear dumper that is fixed to the casing, and meshes with the gear to produce resistance against the urging force of the spring;
a stopper projecting from the tip of the monitor on the side in which the rotation shaft is provided; and
a stopper receiver provided in the position of the casing in which the casing abuts against the stopper when the monitor is rotated to the predetermined angle.

2. The in-vehicle display apparatus according to claim 1, wherein the spring is attached to one end side of the rotation shaft of the monitor, and the gear is fixed to the other end side of the rotation shaft.

3. The in-vehicle display apparatus according to claim 1, wherein the spring has the urging force for holding the monitor in the position when the stopper abuts against the stopper receiver.

4. The in-vehicle display apparatus according to claim 1, wherein the gear is provided in the shape of a sector.
